(19) United States
(12) Patent Application Publication
(10) Pub. No.: US 2012/0137680 A1
(43) Pub. Date: Jun. 7, 2012

(54) TURBOCHARGER PROTECTING METHOD OF ENGINE PROVIDED WITH LP-EGR

(75) Inventor: Kihoon NAM, Gunpo-city (KR)

(73) Assignees: KIA MOTORS CORPORATION, Seoul (KR); HYUNDAI MOTOR COMPANY, Seoul (KR)

(21) Appl. No.: 13/189,347

(22) Filed: Jul. 22, 2011

(30) Foreign Application Priority Data
Dec. 6, 2010 (KR) 10-2010-0123589

(51) Int. Cl. F02B 37/12; F02B 47/08

(52) U.S. Cl. 60/605.2

(57) ABSTRACT

A turbocharger protecting method of an engine provided with an LP-EGR including an engine, a turbocharger disposed downstream of the engine, an exhaust gas post processing device disposed downstream of the turbocharger, an LP-EGR (low pressure exhaust gas recirculation) valve disposed downstream of the exhaust gas post processing device, an LP-EGR cooler disposed downstream of the LP-EGR valve, and an air supply line connecting downstream of the LP-EGR cooler and a compressor of the turbocharger, the turbocharger protecting method includes predetermining compressor inlet limiting temperature, estimating compressor inlet temperature and comparing the estimated compressor inlet temperature and the predetermined compressor inlet limiting temperature, and lowering the compressor inlet temperature if the estimated compressor inlet temperature excesses the predetermined compressor inlet limiting temperature.

### CROSS-REFERENCE TO RELATED APPLICATION

This application claims priority to and the benefit of Korean Patent Application No. 10-2010-0123589 filed Dec. 6, 2010, the entire contents of which application is incorporated herein for all purposes by this reference.

### BACKGROUND OF INVENTION

1. Field of Invention

The present invention relates to a turbocharger protecting method of an engine. More particularly, the present invention relates to a turbocharger protecting method of an engine provided with an LP-EGR.

2. Description of Related Art

Generally, an LP-EGR system means an EGR system which supplies low pressure exhaust gas disposed downstream of a DPF to upstream of a compressor of a turbocharger.

FIG. 4 is a drawing showing a conventional engine provided with an LP-EGR.

Referring to FIG. 4, an LP-EGR system includes an engine 110, a turbocharger 120 disposed downstream of the engine 110, an exhaust gas post processing device 130 disposed do stream of the turbocharger 120, an LP-EGR (low pressure exhaust gas recirculation) valve 140 disposed downstream of the exhaust gas post processing device 130, an LP-EGR cooler 150 disposed downstream of the LP-EGR valve 140, and an air supply line 160 connecting downstream of the LP-EGR cooler 150 and a compressor 122 of the turbocharger 120.

Mixed gas passing by the compressor 122 is cooled in an intercooler 170 and then re-supplied to the engine 110.

The LP-EGR system, as shown in FIG. 4, may further includes a HP-EGR system including a HP-EGR valve 180 and a HP-EGR cooler 190.

In this case, the exhaust gas post processing device 130 may be interpreted including a DPF (Diesel Particulate Filter Trap) or a DOC (diesel oxidation catalyst) or combination thereof.

Comparing to the HP-EGR system which supplies high pressured exhaust gas from an exhaust manifold to an intake manifold directly, the LP-EGR system uses low pressured clean EGR gas downstream of the exhaust gas post processing device and supplies temperature EGR gas.

And thus, the LP-EGR system may improve A/F (air fuel ratio) so as to reduce harmful exhaust gas. And also, the LP-EGR system may enhance distribution characteristic because the EGR gas is supplied to upstream of the compressor of the turbocharger.

If only the LP-EGR system is applied, all exhaust gas may be supplied to a turbine of the turbocharger and thus efficiency of the turbocharger may be enhanced.

However, scheme of the LP-EGR system is complicated and the LP-EGR gas and an intake air is mixed and supplied to the turbocharger compressor so that it is required to limit compressor inlet temperature to protect the compressor.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a turbocharger protecting method of an engine provided with an LP-EGR having advantages of preventing increasing temperature of a compressor of the turbocharger so as to enhance durability of the turbocharger.

Also, various aspects of the present invention provide for a turbocharger protecting method of an engine provided with an LP-EGR having advantages of efficiently lowering temperature of mixed gas inflowing the compressor of the turbocharger so as to enhance engine efficiency.

A turbocharger protecting method of an engine provided with an LP-EGR including an engine, a turbocharger disposed downstream of the engine, an exhaust gas post processing device disposed downstream of the turbocharger, an LP-EGR (low pressure exhaust gas recirculation) valve disposed downstream of the exhaust gas post processing device, an LP-EGR cooler disposed downstream of the LP-EGR valve, and an air supply line connecting downstream of the LP-EGR cooler and a compressor of the turbocharger, the turbocharger protecting method according to various aspects of the present invention may include predetermining compressor inlet limiting temperature, estimating compressor inlet temperature and comparing the estimated compressor inlet temperature and the predetermined compressor inlet limiting temperature, and lowering the compressor inlet temperature if the estimated compressor inlet temperature excesses the predetermined compressor inlet limiting temperature.

The compressor inlet limiting temperature may be predetermined according to engine operation state including an engine speed and an engine load.

Flow amount of exhaust gas flowing through the LP-EGR valve may be calculated from an effective flow amount area of the LP-EGR valve, upstream pressure of the LP-EGR valve, upstream temperature of the LP-EGR valve and pressure ratio between the upstream pressure of the LP-EGR valve and downstream pressure of the LP-EGR cooler, temperature of the exhaust gas flowing through the LP-EGR cooler may be calculated from coolant temperature of the LP-EGR cooler and cooling efficiency of the LP-EGR cooler and the compressor inlet temperature may be estimated from measured mass flow amount and temperature of fresh air inflowing the air supply line, the calculated flow amount of exhaust gas flowing through the LP-EGR valve and the calculated temperature of the exhaust gas flowing through the LP-EGR cooler.

The pressure ratio between the upstream pressure of the LP-EGR valve and the downstream pressure of the LP-EGR cooler may be calculated by assuming the downstream pressure of the LP-EGR cooler as atmospheric pressure.

The lowering the compressor inlet temperature may include reducing opening amount of the LP-EGR valve to reduce inlet temperature of the compressor.

The lowering the compressor inlet temperature may include increasing air flowing amount through the air supply line to reduce inlet temperature of the compressor.

The lowering the compressor inlet temperature may include reducing opening amount of the LP-EGR valve and simultaneously increasing air flowing amount through the air supply line to reduce inlet temperature of the compressor.

The lowering the compressor inlet temperature may further include increasing opening amount of a HP-EGR valve if the engine provided with the LP-EGR further includes HP-EGR (high pressure exhaust gas recirculation) and the HP-EGR valve.

An emergency filter may be disposed between the LP-EGR valve and the LP-EGR cooler.

A turbocharger protecting method of an engine provided with an LP-EGR according to various aspects of the present invention may monitor turbocharger compressor inlet temperature without temperature sensor in real time.

Prediction control for the compressor inlet temperature is possible so that control precision may be improved and turbocharger durability may be enhanced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a drawing showing an exemplary engine provided with an LP-EGR according to the present invention.

FIG. 2 is a drawing showing a control volume for modeling which is applied to an exemplary engine provided with an LP-EGR according to the present invention.

FIG. 3 is a flowchart showing an exemplary control method for protecting a turbocharger of an engine provided with an LP-EGR according to the present invention.

FIG. 4 is a drawing showing a conventional engine provided with an LP-EGR.

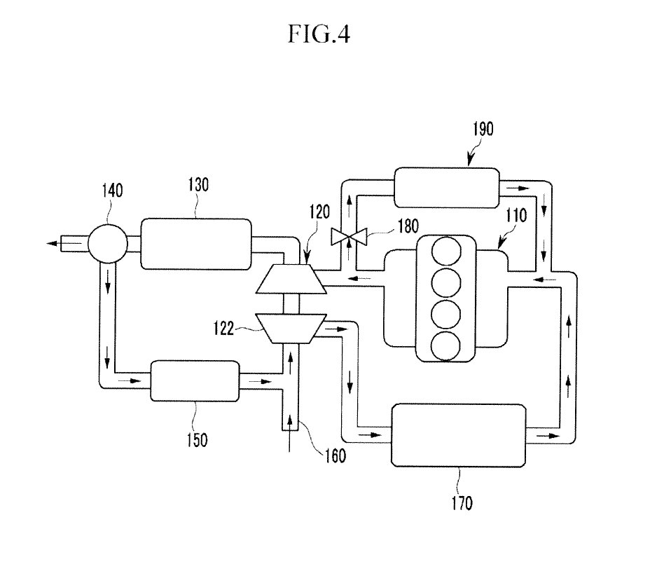

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

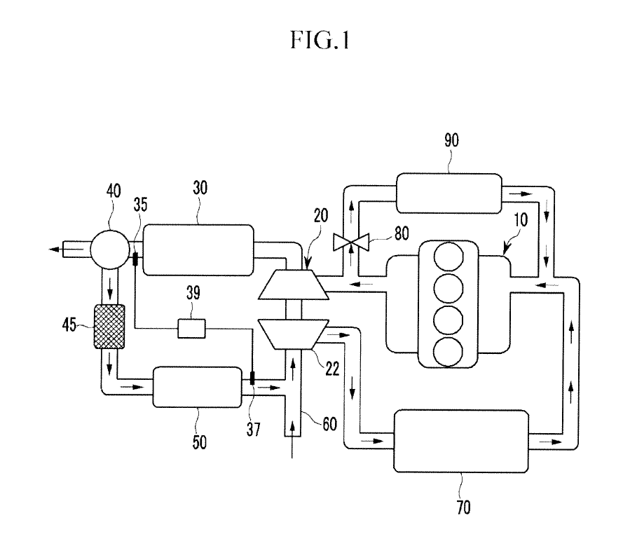

Referring to FIG. 1, a system provided with an LP-EGR according to various embodiments of the present invention an engine 10, a turbocharger 20 disposed downstream of the engine 10, an exhaust gas post processing device 30 disposed downstream of the turbocharger 20, an LP-EGR (low pressure exhaust gas recirculation) valve 40 disposed downstream of the exhaust gas post processing device 30, an LP-EGR cooler 50 disposed downstream of the LP-EGR valve 40, and an air supply line 60 connecting downstream of the LP-EGR cooler 50 and a compressor 22 of the turbocharger 20.

And an intercooler 70 for cooling mixed gas flowing the compressor 22 is disposed and the mixed gas flowing the intercooler 70 is supplied to the engine 10.

The exhaust gas post processing device 30 may be defined as a DPF (Diesel Particulate Filter Trap) or a DOC (Diesel Oxidation Catalyst) or combination thereof.

An emergency filter 45 is disposed between the LP-EGR valve 40 and the LP-EGR cooler 50 and the emergency filter 45 may prevent the exhaust gas to inflow into an intake system of the engine when the DPF and so on is damaged.

The system provided with the LP-EGR according to various embodiments of the present invention may further include HP-EGR system, for example, may further include a HP-EGR valve 80 and a HP-EGR cooler 90.

The system provided with the LP-EGR according to various embodiments of the present invention may further include a differential pressure sensor 39 for detecting differential pressure between upstream of the LP-EGR valve 40 and downstream of the LP-EGR cooler 50 or the system may further include a first sensor 35 detecting pressure of upstream of the LP-EGR valve 40 or the system may further include a first sensor 35 detecting pressure of upstream of the LP-EGR valve 40 and a second sensor 37 detecting pressure of downstream of the LP-EGR cooler 50.

If the differential pressure sensor 39 is disposed, upstream pressure of the LP-EGR valve 40 may be estimated by using differential pressure between upstream of the LP-EGR valve 40 and downstream of the LP-EGR cooler 50 and assuming downstream of the LP-EGR cooler 50 as atmospheric pressure.

If the first sensor 35 detecting upstream pressure of the LP-EGR valve 40, pressure ratio between upstream of the LP-EGR valve 40 and downstream of the LP-EGR cooler 50 may be estimated by assuming downstream of the LP-EGR cooler 50 as atmospheric pressure.

If the first sensor 35 detecting upstream pressure of the LP-EGR valve 40 and the second sensor 37 detecting downstream of the LP-EGR cooler 50, pressure ratio between upstream of the LP-EGR valve 40 and downstream of the LP-EGR cooler 50 may be calculated by the detected pressures.

In this case, the first sensor 35 may be a separated sensor disposed between the exhaust gas post processing device 30 and the LP-EGR valve 40 or the first sensor 35 may be replaced by a sensor detecting pressure within the exhaust gas post processing device 30.

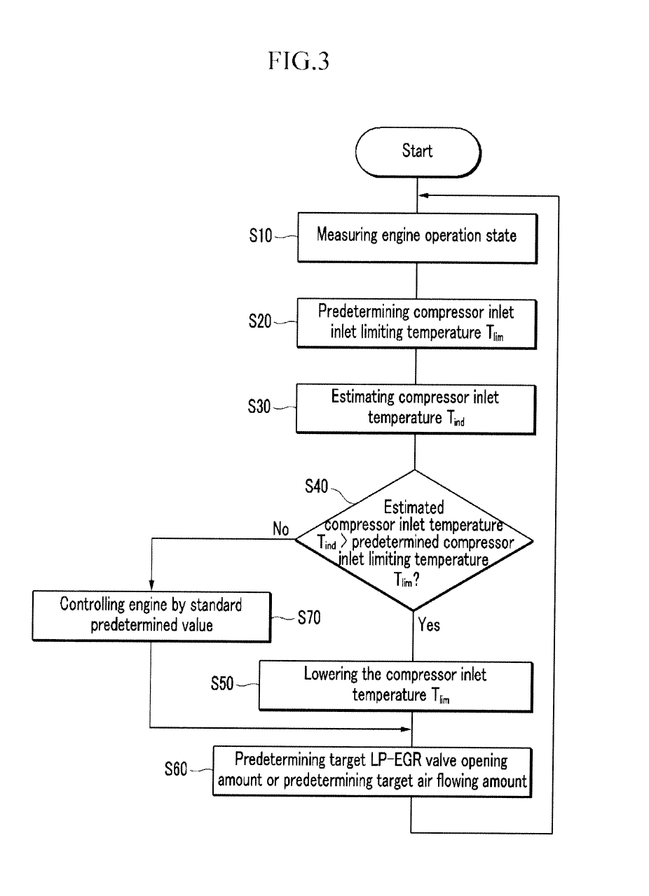

Hereinafter, referring to FIG. 1 and FIG. 3, a turbocharger protecting method of an engine provided with an LP-EGR according to various embodiments of the present invention will be described.

The control method of an engine provided with the LP-EGR according various embodiments of the present invention includes measuring engine operation state S10, predetermining compressor inlet limiting temperature Tₗᵢₘ S20, estimating compressor inlet temperature T_{ind} S30, comparing the estimated compressor inlet temperature T_{ind} and the predetermined compressor inlet limiting temperature Tₗᵢₘ S40 and lowering the compressor inlet temperature Tₗᵢₘ when the estimated compressor inlet temperature T_{ind} excesses the predetermined compressor inlet limiting temperature Tₗᵢₘ S50.

The compressor inlet limiting temperature Tₗᵢₘ may be a predetermined value by experiments according to engine operation states including engine speed and engine load.

For example, the compressor inlet limiting temperature Tₗᵢₘ may be determined by a predetermined map made by experiment considering material of the compressor 22.

Flow amount \dot{m}_{LP-EGR} of exhaust gas flowing through the LP-EGR valve 40 is calculated from an effective flow amount area (EFA) of the LP-EGR valve 40, upstream pressure of the LP-EGR valve Pₑₓₕ, upstream temperature of the LP-EGR valve Tₑₓₕ and pressure ratio PR between the upstream pressure of the LP-EGR valve Pₑₓₕ and downstream pressure of the LP-EGR cooler P_{ind} Temperature of the exhaust gas Tₒᵤₜ flowing through the LP-EGR cooler 50 is calculated from coolant temperature of the LP-EGR cooler T_{coolant} and cooling efficiency η of the LP-EGR cooler. And the compressor inlet temperature T_{ind} is estimated from measured mass flow amount \dot{m}_{Air} and temperature of fresh air T_{Air}, inflowing the air supply line 60, the calculated flow amount of exhaust gas \dot{m}_{LP-EGR} flowing through the LP-EGR valve 40 and the calculated temperature of the exhaust gas Tₒᵤₜ flowing through the LP-EGR cooler 40.

The pressure ratio PR between the upstream pressure Pₑₓₕ of the LP-EGR valve 40 and the downstream pressure P_{ind} of the LP-EGR cooler 50 is calculated by assuming the downstream pressure P_{ind} of the LP-EGR cooler 50 as atmospheric pressure.

That is, the downstream pressure P_{ind} of the LP-EGR cooler 40 may be detected by the second sensor 37 or the pressure ratio PR between the upstream pressure Pₑₓₕ of the LP-EGR valve 40 and the downstream pressure P_{ind} of the LP-EGR cooler 50 may be calculated by assuming the downstream pressure P_{ind} of the LP-EGR cooler 50 as atmospheric pressure.

The flow amount \dot{m}_{LP-EGR} of the exhaust gas flowing through the LP-EGR valve 40 may be calculated as follow.

$${\dot{m}}_{LP - EGR} = \frac{EFA \times {P}_{exh}}{\sqrt{R \times {T}_{exh}}} \times {PR}^{\frac{1}{κ}} \times {[ \frac{2 κ}{κ - 1} \times ( 1 - {PR}^{\frac{κ - 1}{κ}} ) ]}^{\frac{1}{2}} \\ ( if PR > {P}_{cr} ) \\ {\dot{m}}_{LP - EGR} = \frac{EFA \times {P}_{exh}}{\sqrt{R \times {T}_{exh}}} \times {κ}^{\frac{1}{2}} \times {( \frac{2}{κ + 1} )}^{\frac{κ + 1}{2 ( κ - 1 )}} \\ ( else ) \\ {P}_{cr} = {( \frac{2}{κ + 1} )}^{\frac{κ}{κ - 1}} \qquad Equation 1$$

The equation 1 represents ideal flow amount flowing through the LP-EGR valve 40 using ideal gas equation and isentropic equation, but real flow is not one dimensional, stationary state and adiabatic reversible process, and thus effective flow amount area (EFA) is included for compensation.

The effective flow amount area (EFA) is effective flow amount area of the variable LP-EGR valve 40.

In this case, the Tₑₓₕ is temperature of the exhaust gas flowing into the LP-EGR valve 40, and the Tₑₓₕ may be measured value by a separate temperature sensor or be measured value by a sensor which is disposed within the exhaust gas post processing device 30 to control the exhaust gas post processing device 30.

The temperature Tₒᵤₜ of the exhaust gas flowing through the LP-EGR cooler is calculated as follows.

Tₒᵤₜ=Tᵢₙ−η(Tᵢₙ−T_{coolant}) Equation 2

Assuming pressure drop flowing through the LP-EGR cooler 50 does not occur, cooling efficiency η of the LP-EGR cooler 50 may be determined by experiments and then the temperature Tₒᵤₜ of the exhaust gas flowing through the LP-EGR cooler is calculated.

In this case, the Tᵢₙ is assumed as the temperature Tₑₓₕ of the exhaust gas flowing into the LP-EGR valve 40.

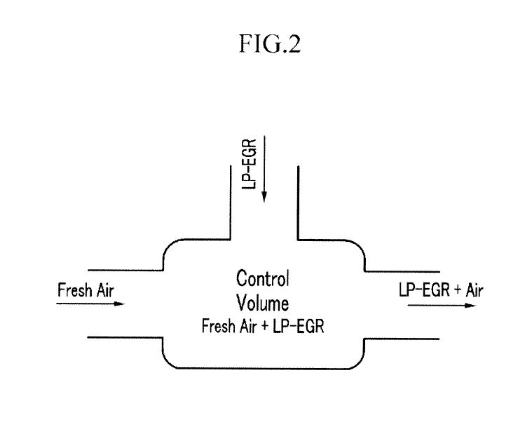

FIG. 2 is a drawing showing a control volume for modeling which is applied to an engine provided with an LP-EGR according to various embodiments of the present invention.

Referring to FIG. 2 and FIG. 3, the compressor inlet temperature T_{ind} is calculates as follows using energy equation.

$${\dot{P}}_{ind} = \frac{R}{{c}_{v\_ind} \times {V}_{ind}} ( {c}_{{P}_{Air}} {\dot{m}}_{Air} {T}_{Air} + {c}_{{P}_{LP} - EGR} {\dot{m}}_{LP - EGR} {T}_{LP - EGR} - {c}_{P\_ind} {\dot{m}}_{ind} {T}_{ind} ) \\ {\dot{m}}_{ind} = {\dot{m}}_{Air} + {\dot{m}}_{LP - EGR} \qquad Equation 3$$

In this case, it is assumed that thermodynamic states including pressure, temperature, air constitute are uniform within entire volume, heat transfer or mass flowing through boundary does not occur, energy change within fluid flowing does not occur, and ideal gas equation may be applied to a fluid within control volume.

Mass change rate of the mixed gas may be calculated by using the law of conservation of mass. In this case, the \dot{m}_{Air} and the T_{Air} are measured value, the \dot{m}_{LP-EGR} is calculated value previously, and the T_{LP-EGR} is the exhaust gas temperature Tₒᵤₜ flowing through the LP-EGR cooler.

If the pressure change rate \dot{P}_{ind} is assumed “0”, mixed gas temperature T_{ind} flowing into the compressor may be calculated.

The lowering the compressor inlet temperature the compressor inlet temperature S50 may be realized by reducing opening amount of the LP-EGR valve 40 so as to reduce supplying relatively high temperature exhaust gas, and thus gas temperature flowing into the compressor 22 may be reduced.

The lowering the compressor inlet temperature the compressor inlet temperature S50 may be realized by increasing air flowing amount through the air supply line 60 to reduce inlet temperature of the compressor 22.

That is, if the inflowing air amount \dot{m}_{Air} into the air supply line 60 which has relatively low temperature is increased, the gas temperature inflowing into the compressor 22 may be lowered.

The lowering the compressor inlet temperature S50 may be realized by reducing opening amount of the LP-EGR valve 40 and simultaneously increasing air flowing amount through the air supply line 60 to reduce inlet temperature of the compressor 22.

The controlling of reducing the opening amount of the LP-EGR valve 40 or increasing the air inflowing amount into the air supply line 60 may be predetermined basis on experiments.

If the engine provided with the LP-EGR further includes a HP-EGR (high pressure exhaust gas recirculation) and a HP-EGR valve 80, the lowering the compressor inlet temperature S50 may be realized by increasing opening amount of the HP-EGR valve 80.

If opening amount of the HP-EGR valve 80 is increased, relative air flowing amount through the turbocharger 20 is reduced, and relative exhaust gas amount supplied to the compressor 22 is reduced, and thus gas temperature inflowing into the compressor 22 may be reduced.

The turbocharger protecting method of an engine provided with an LP-EGR according to various embodiments of the present invention further includes predetermining target LP-EGR valve opening amount S60.

The target LP-EGR valve opening amount feeds back to the predetermined map as compensation control, for example, in the lowering the compressor inlet temperature S50, real temperature change and estimated temperature change are compared and then in the next control, the opening amount of the LP-EGR valve 40 is increase or decreased so that more precise control may be possible.

The turbocharger protecting method of an engine provided with an LP-EGR according to various embodiments of the present invention further includes predetermining target air flowing amount \dot{m}_{Air} S60.

The target air flowing amount \dot{m}_{Air} feeds back to the predetermined map as compensation control, for example, in the lowering the compressor inlet temperature S50, real temperature change and estimated temperature change are compared and then in the next control, the air flowing amount \dot{m}_{Air} supplying into the air supply line 60 is increase or decreased so that more precise control may be possible.

The turbocharger protecting method of an engine provided with an LP-EGR according to various embodiments of the present invention further includes controlling the engine by standard predetermined value S70 if the estimated compressor inlet temperature T_{ind} does not excess the predetermined compressor inlet limiting temperature Tₗᵢₘ.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A turbocharger protecting method of an engine provided with low pressure exhaust gas recirculation (LP-EGR) including a turbocharger disposed downstream of the engine, an exhaust gas post processing device disposed downstream of the turbocharger, an LP-EGR valve disposed downstream of the exhaust gas post processing device, an LP-EGR cooler disposed downstream of the LP-EGR valve, and an air supply line connecting downstream of the LP-EGR cooler and a compressor of the turbocharger, the turbocharger protecting method comprising:
predetermining compressor inlet limiting temperature;
estimating compressor inlet temperature; and
comparing the estimated compressor inlet temperature and the predetermined compressor inlet limiting temperature, and lowering the compressor inlet temperature if the estimated compressor inlet temperature excesses the predetermined compressor inlet limiting temperature.

2. The turbocharger protecting method of claim 1, wherein the compressor inlet limiting temperature is predetermined according to an engine operation state including an engine speed and an engine load.

3. The turbocharger protecting method of claim 1, wherein:
flow amount of exhaust gas flowing through the LP-EGR valve is calculated from an effective flow amount area of the LP-EGR valve, upstream pressure of the LP-EGR valve, upstream temperature of the LP-EGR valve and pressure ratio between the upstream pressure of the LP-EGR valve and downstream pressure of the LP-EGR cooler;
temperature of the exhaust gas flowing through the LP-EGR cooler is calculated from coolant temperature of the LP-EGR cooler and cooling efficiency of the LP-EGR cooler; and
the compressor inlet temperature is estimated from measured mass flow amount and temperature of fresh air inflowing the air supply line, the calculated flow amount of exhaust gas flowing through the LP-EGR valve and the calculated temperature of the exhaust gas flowing through the LP-EGR cooler.

4. The turbocharger protecting method of claim 1, wherein the pressure ratio between the upstream pressure of the LP-EGR valve and the downstream pressure of the LP-EGR cooler is calculated by assuming the downstream pressure of the LP-EGR cooler as atmospheric pressure.

5. The turbocharger protecting method of claim 1, wherein the lowering the compressor inlet temperature comprises reducing opening amount of the LP-EGR valve to reduce inlet temperature of the compressor.

6. The turbocharger protecting method of claim 5, wherein the lowering the compressor inlet temperature further comprises increasing opening amount of a high pressure exhaust gas recirculation (HP-EGR) valve if the engine provided with the LP-EGR further includes HP-EGR and the HP-EGR valve.

7. The turbocharger protecting method of claim 1, wherein the lowering the compressor inlet temperature comprises increasing air flowing amount through the air supply line to reduce inlet temperature of the compressor.

8. The turbocharger protecting method of claim 7, wherein the lowering the compressor inlet temperature further comprises increasing opening amount of a high pressure exhaust gas recirculation (HP-EGR) valve if the engine provided with the LP-EGR further includes HP-EGR and the HP-EGR valve.

9. The turbocharger protecting method of claim 1, wherein the lowering the compressor inlet temperature comprises reducing opening amount of the LP-EGR valve and simultaneously increasing air flowing amount through the air supply line to reduce inlet temperature of the compressor.

10. The turbocharger protecting method of claim 9, wherein the lowering the compressor inlet temperature further comprises increasing opening amount of a high pressure exhaust gas recirculation (HP-EGR) valve if the engine provided with the LP-EGR further includes HP-EGR and the HP-EGR valve.

11. The turbocharger protecting method of claim 1, wherein an emergency filter is disposed between the LP-EGR valve and the LP-EGR cooler.
